(19) United States
(12) Patent Application Publication
(10) Pub. No.: US 2016/0118716 A1
(43) Pub. Date: Apr. 28, 2016

(54) System and Method for Beam Alignment

(71) Applicant: Huawei Technologies Co., Ltd., Shenzhen (CN)

(72) Inventors: Alex Stephenne, Stittsville (CA); Aaron James Callard, Ottawa (CA); Philippe Leroux, Ottawa (CA)

(21) Appl. No.: 14/522,173

(22) Filed: Oct. 23, 2014

(51) Int. Cl. H01Q 3/34

(52) U.S. Cl. CPC H01Q 3/34

(57) ABSTRACT

In one embodiment, a method for beam alignment includes determining an orientation of a device and performing angle compensation in accordance with the orientation of the device. The method also includes performing beamforming adaptation and modifying the beamforming adaptation in accordance with the orientation of the device.

### TECHNICAL FIELD

The present invention relates to a system and method for communications, and, in particular, to a system and method for beam alignment.

### BACKGROUND

Terrestrial wireless communication systems may use a microwave frequency range from several hundred MHz to a few GHz, corresponding to wavelengths in the range of a few centimeters to a meter. In this range, wave propagation is robust and resonant antennas are sufficiently small to be used on portable devices but sufficiently large to radiate and capture a substantial amount of electromagnetic energy. Microwaves are not typically highly directional.

Millimeter waves may be used for point to point fixed links and for communications with nomadic devices having relatively low range of movement, such as Personal Area Networks, WiFi, Institute of Electrical and Electronics Engineers (IEEE) 802.15.3c, and IEEE 802.1 lad. For example, once a millimeter wave communication is set up, the devices may be relatively stationary. Transmit and receive beams may be aligned, because millimeter waves may be highly directional. The highly directional nature of millimeter waves may be achieved by packing many millimeter wave antennas in a small area. Despite the relatively stationary nature of the devices, slight movements, including rotation of the antennas, can have adverse effects on the reception. In point-to-point fixed links, the initial beam alignment is performed manually. For relatively low range communications of nomadic devices, beam alignment is performed relatively infrequently, because of the directivity limit of the phase array. Because of the directivity limit, however, the antenna gain may be relatively small.

### SUMMARY

An embodiment method for beam alignment includes determining an orientation of a device and performing angle compensation in accordance with the orientation of the device. The method also includes performing beamforming adaptation and modifying the beamforming adaptation in accordance with the orientation of the device.

An embodiment device includes a beam transmitter, where the beam transmitter includes a phase array including a plurality of antennas, where the plurality of antennas is configured to transmit a beam to a receiver and a plurality of phase shifters coupled to the phase array. The beam transmitter also includes an inertial navigation system configured to determine an orientation of the device and a beamforming module configured to perform analog beamforming on the plurality of phase shifters in accordance with the orientation of the device.

An embodiment device including a beam receiver, where the beam receiver includes a phase array including a plurality of antennas, where the plurality of antennas is configured to receive a beam to a receiver and a plurality of phase shifters coupled to the phase array. The beam receiver also includes an inertial navigation system configured to determine an orientation of the beam receiver and a beamforming module configured to perform analog beamforming on the plurality of phase shifters in accordance with the orientation of the beam receiver.

An embodiment controller includes a processor and a non-transitory computer readable storage medium storing programming for execution by the processor. The programming including instructions to determine an orientation of a device and perform angle compensation in accordance with the orientation of the device. The programming also includes instructions to perform beamforming adaptation and modify the beamforming adaptation in accordance with the orientation of the device.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a diagram of a wireless network for communicating data;

FIG. 2 illustrates an embodiment millimeter wave transmitter and receiver;

FIG. 3 illustrates an embodiment millimeter wave transmitter;

FIG. 4 illustrates an embodiment millimeter wave receiver;

FIG. 5 illustrates another embodiment millimeter wave transmitter;

FIG. 6 illustrates another embodiment millimeter wave receiver;

FIG. 7 illustrates a flowchart of an embodiment method of transmitting millimeter waves;

FIG. 8 illustrates a flowchart of an embodiment method of receiving millimeter waves; and

FIG. 9 illustrates a block diagram of an embodiment general-purpose computer system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

It is desirable for millimeter waves (mm waves) to be used in a cellular context for access links for a fully mobile terminal. A phase array may have a high directivity with pencil beams, so tracking may be problematic in the beam alignment process.

Movable devices often include global positioning system (GPS) receivers, or other such location determination systems, which may obtain the position of the movable devices. Also, movable devices may have accelerometers and/or gyroscopes to estimate the tilt or rotation of the device, and possibly enhance the positioning accuracy. An inertial navigation system (INS) in a movable device may make use of GPS, accelerometers, and/or gyroscopes to estimate the position, orientation, and velocity, including the direction and speed of movement in three dimensions, of a moving movable device. A movable device may be any device capable of movement, including mobile devices, such as user equipments, and devices with some movement, such as access/backhaul nodes which experience motion from manipulation, wind, or other causes. With an INS, the position and orientation of a device with an INS which uses millimeter wave pencil beams for communications may be tracked. Rotation, and optionally displacement of the device may be compensated for at the analog and/or digital beamforming phase with a rough estimate of the device orientation. Then, the fine-tuning phase may be performed using analog and/or digital tracking.

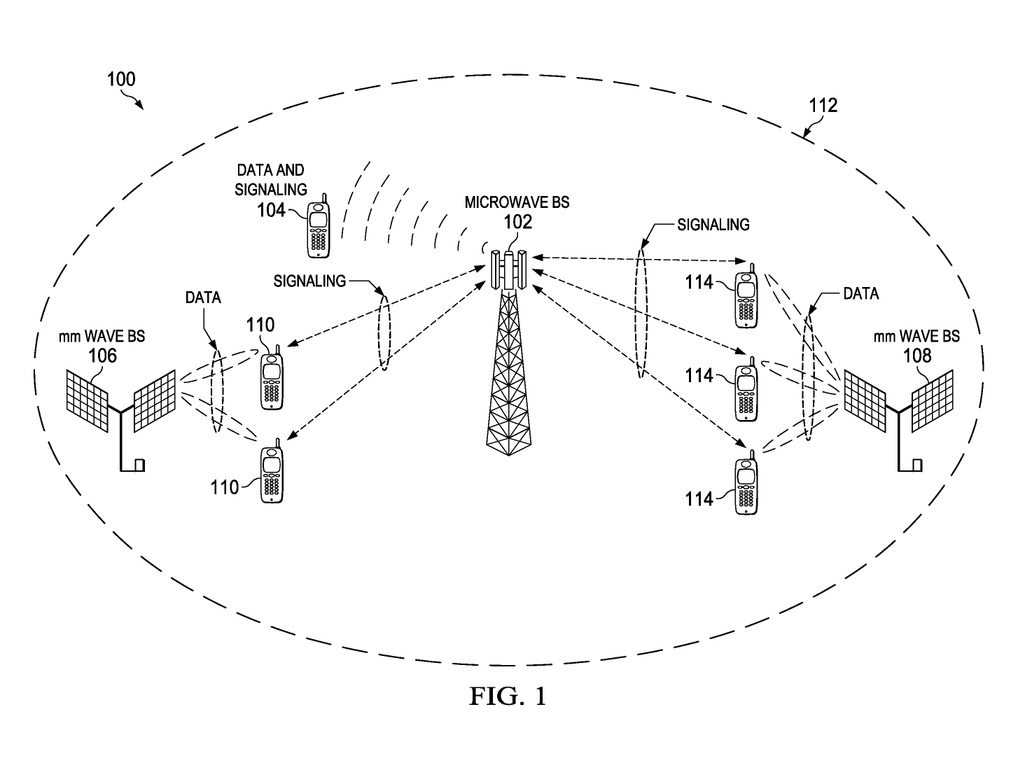

FIG. 1 illustrates network 100 for communicating data. Network 100 has soft cells or phantom cells, where millimeter waves are employed for payload data transmission from short-range access points, while the control plane operates at microwave frequencies from macro base stations. This facilitates stable and reliable control connections, where extremely fast data transmissions occur between users and millimeter wave stations. Sporadic interruptions of the millimeter wave links of limited duration may have only minor effects on the communication channel, as the control links remain in place and lost data may be recovered through retransmissions.

Network 100 includes communications controller 102, a microwave communications controller or macro base station, having a coverage area 112. Communications controller 102 communicates with user equipment (UE) 104 by transmitting and receiving data and signaling information in the microwave range. Communications controller 102 also communicates with communications controllers 106 and 108 which are millimeter wave communications controllers. Communications controllers 106 and 108 communicate with UEs 110 and 114, respectively, using millimeter waves. Communications controllers 102, 106, and 108 may be any component capable of providing wireless access by, inter alia, establishing uplink and/or downlink connections with UEs 104, 110, and 114, such as a base station, a NodeB, an enhanced NodeB (eNB), an access point, a picocell, a femtocell, and other wirelessly enabled devices. UEs 104, 110, and 114 may be any component capable of establishing a wireless connection with communications controller 102, such as cell phones, smart phones, tablets, sensors, etc.

Mobility in mm waves involves changes in the relative position of the devices and changes in the relative orientation of the two devices. Position changes which do not change the line of sight conditions have relatively small impacts of the suitable angle of departure (DoD) and angle of arrival (DoA), and may be relatively easily tracked. Rotations of either the directional transmitter or receiver affect the suitable DoD/DoA.

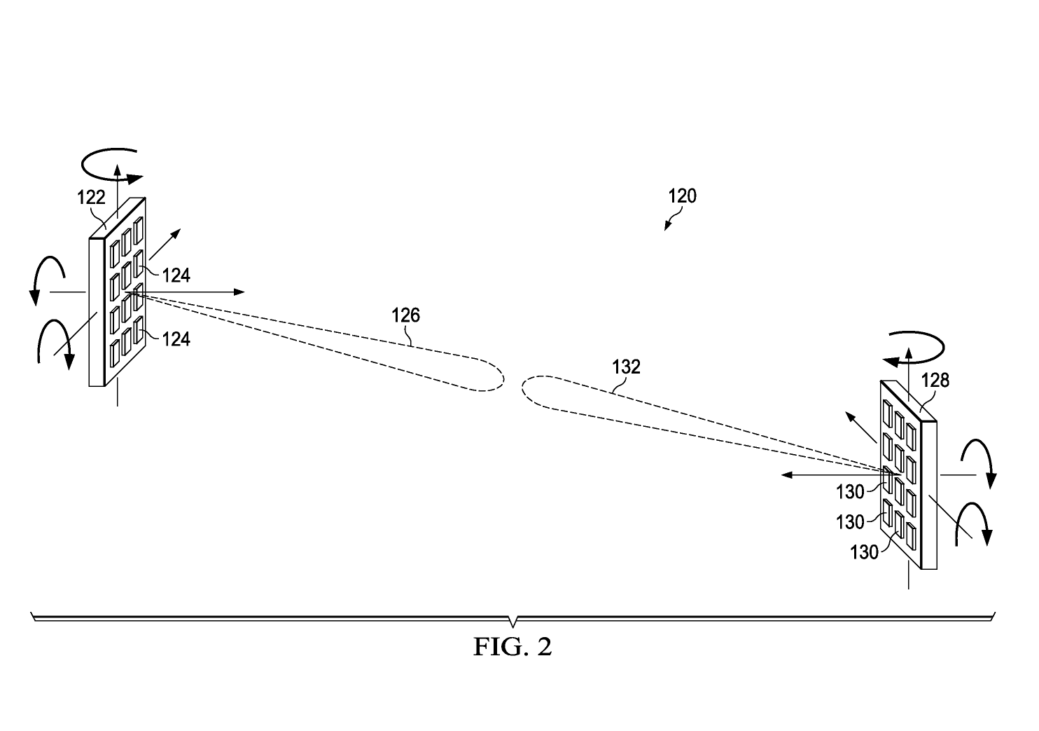

FIG. 2 illustrates millimeter wave communications system 120. Phase array 122 with antennas 124 produces millimeter wave beam 126 directed towards phase array 128. Phase array 128 which has antennas 130 receives millimeter wave beam 132 from phase array 122.

Two technologies used in directional wireless communications networks (DWNs) include free space optics (FSO) and millimeter waves. DWNs involve steering beams, acquiring links, and tracking to maintain connectivity.

In one example, transceivers are mounted on and rotated by a mechanical positioning platform, such as a gimbal, may use GPS receivers, accelerometers, gyroscopes, magnetometers, and/or digital compasses to keep track of position and orientation of the transceivers. Spiral scanning or raster scanning may be used to maintain links. Position information may be obtained using GPS. Two orientation angles determined with respect to earth's gravity, pitch and roll, may be measured using inclinometers in a static situation. The yaw may be determined by integrating a gyroscope's velocities over time. Alternatively, digital compasses are used. In another example, the yaw angle is determined by observing the GPS coordinates over time and finding the platform's heading. In other examples, attitude heading reference system (AHRS) is used. These modules integrate gyroscopes, accelerometers, magnetometers, temperature and pressure sensors, and GPS to provide position and orientation solutions to a mobile platform. Other sensors provide error correction to the gyroscopes.

In another example, a phased array is used, for which relative angular position acquisition is used.

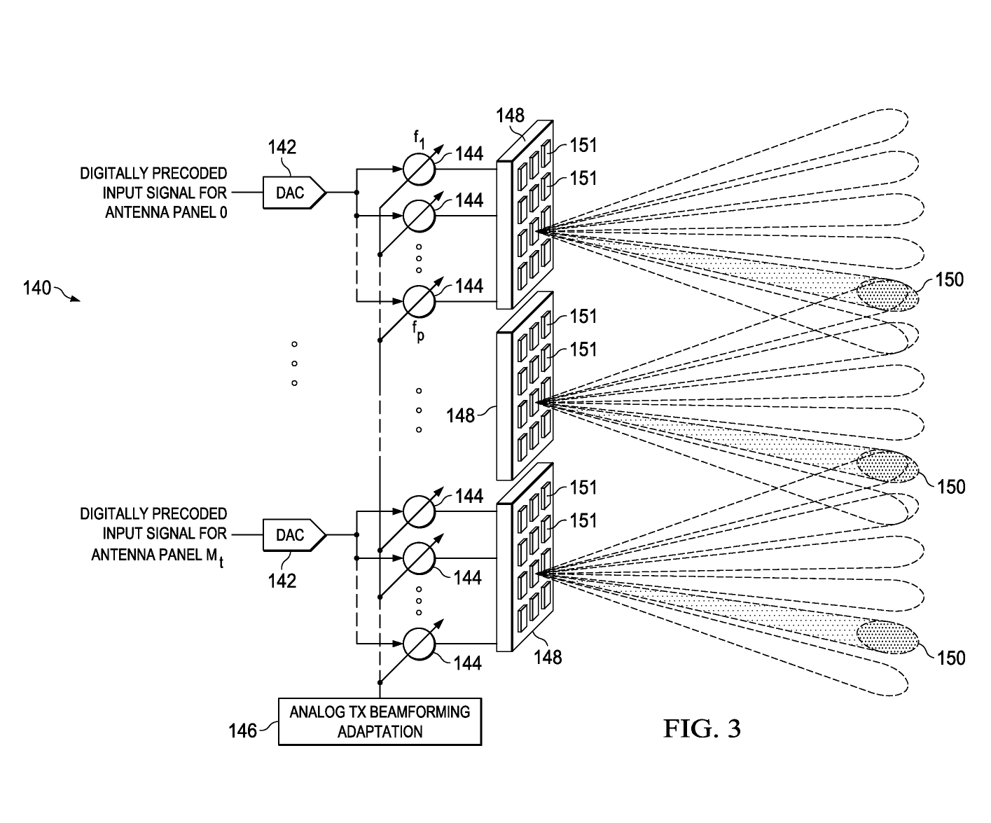

FIG. 3 illustrates millimeter wave transmitter 140. Digitally pre-coded input signals for antenna panel 0 through antenna panel Mₜ are sent to digital-to-analog converters (DACs) 142, where the signals are converted from digital signals to analog signals. These are the signals to be transmitted.

Phase shifters 144 apply currents to antennas 151 based on the signals from DACs 142 and analog beamforming adaptation block 146. The current sources cause the phased array to transmit a millimeter wave beam with the information towards the receiver. Beamforming causes antennas 151 of phase arrays 148 to output beams 150 so particular angles experience constructive interference while other angles experience destructive interference. By causing constructive interference to occur in a particular direction, a pencil beam may be transmitted in that direction.

Beamforming is used for both transmitting and receiving to achieve spatial selectivity so a pencil beam is transmitted by the transmitter and received by the receiver. To change the directionality of the array when transmitting, a beamformer controls the phase and relative amplitude of the signal at each antenna to create a pattern of constructive or destructive interference in the wave fronts. Analog beamforming using digitally controlled phase shifters reduces the power consumption and complexity of a large number of radio frequency (RF) chains in an array. Duplex analog beamforming may be implemented with one ADC and one DAC. The transmit data is multiplied by a transmit beamforming unit normalization vector.

Analog beamforming adaptation block 146 performs analog beamforming. Beamforming may involve handshaking between the transmitter and receiver. In one example, several combinations of phase angles between the transmitter and receiver are tested. For example, the receiver selects an angle, and the transmitter steps through several angles to find the best transmission. Then, the receiver selects another angle, and the transmitter steps through several angles. These may be the same angles as before. This process continues, until a selected pair of angles is found.

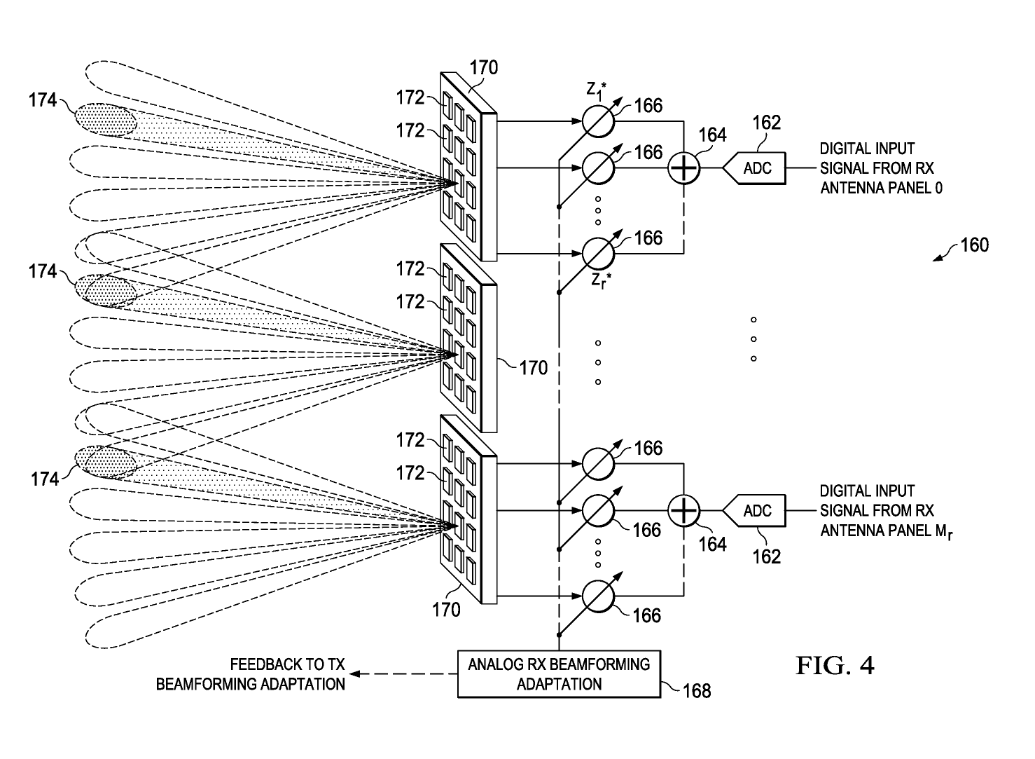

FIG. 4 illustrates millimeter wave receiver 160. Beams 174, pencil beams, are received by antennas 172 in phase arrays 170 to produce signals Z₁* through Zᵣ*. The detected signals are sent to phase shifters 166. Phase shifters 166 output the signals in accordance with the signals detected by antennas 172 Z₁* through Zᵣ* and from analog receiving beamforming adaptation unit 168.

Analog receiving beamforming adaptation unit 168 provides feedback to the beamforming adaptation block 146. In one example, several different angles for the receiver and a transmitter are considered to determine the best angle of several angles. In one example, the receiver steps through several angles. The transmitter tries a different angle, and the receiver again steps through multiple angles. A suitable angle is found in accordance with this process.

Information from different antennas is combined so the expected pattern of radiation is observed with a bias in receiving a signal in the expected direction. The signals for an antenna panel are combined by combiners 164 and passed on to analog-to-digital converters (ADCs) 162, which convert the signals from the analog domain to the digital domain. The digital input signals from receiving antenna panel 0 through receiving antenna panel Mᵣ are output. The received signals on the antennas are combined by combiners using a receive combining unit normalization vector. The combiners output at discrete channels. Digital beamforming may also be performed in the digital domain.

Movable devices may include GPS receivers, accelerometers and/or gyroscopes to determine the tilt or rotation of the device and enhance the positioning accuracy. GPS, accelerometers, and gyroscopes are used in inertial navigation systems (INS) to estimate the position, orientation, and velocity, where the velocity includes both linear and angular velocity. With an INS, the position and orientation of a device are tracked to facilitate the use of millimeter wave pencil beams for communications. An embodiment uses GPS units, accelerometers, gyroscopes, magnetometers, and/or digital compasses with a phased-array apparatus for relatively movable devices, such as terminals or access/backhaul nodes which experience motion from manipulation, wind, or other causes. The rotation and optionally the displacement of the device are continuously compensated for at the analog and/or digital beamforming phases with a rough estimate of the motion. Fine tuning may be performed in the analog or digital tracking phase.

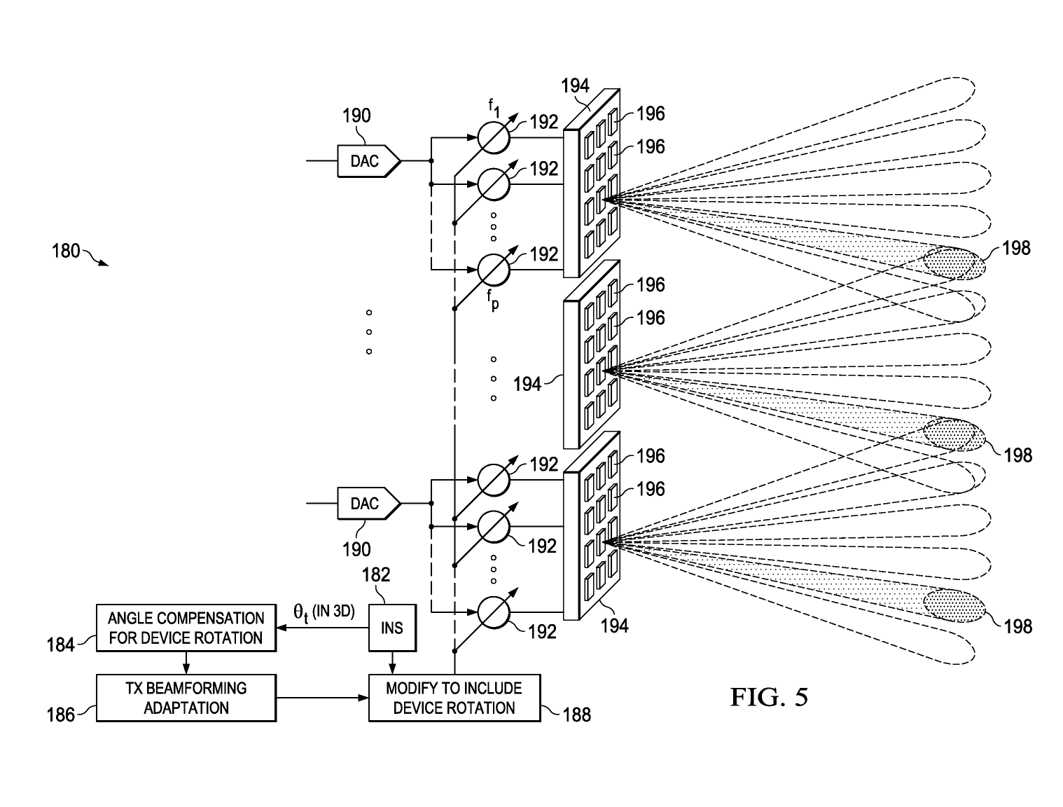

FIG. 5 illustrates millimeter wave transmitter 180. INS 182 determines the position, orientation, and velocity of the device, including angular momentum. INS 182 may have access to GPS receivers, accelerometers, gyroscopes, magnetometers, and/or digital compasses. INS 182 may be any device which provides orientation information. The INS determines the position and orientation of millimeter wave transmitter 180 in a device. GPS is a satellite enabled positioning system which allows a GPS receiver to determine its geographic location. Accelerometers determine the proper acceleration, which is the physical acceleration experienced by millimeter wave transmitter 180. Gyroscopes measure the orientation based on the angular momentum. Gyroscopes may be electronic, microchip-packaged micro-electro-mechanical-systems (MEMS) gyroscopes, solid state ring lasers, fiber-optic gyroscopes, quantum gyroscopes or other such gyroscopes. Magnetometers measure the magnetic field at a point in space, which may be used as a digital compass. Based on the signals from the various sensors, the position and orientation are determined. A beam angle rotation estimator may be used to enhance the INS measurements. For example, a low accuracy INS, for example an INS used in a gaming application on a terminal, the INS orientation estimation may be enhanced by observing the output of the beam tracking process. This information is passed to angle compensation block 184 and device rotation block 188 in the form of θₜ, the transmission angle, in three dimensions, a continuous real time signal indicating the angle of the device relative to a reference angle. The angle indicates the 3D phase rotation.

Angle compensation block 184 determines the angular compensation for the device performance. That is, it determines how the transmit/receive angle is to be modified in accordance with the current device orientation. There may be a delay between antenna elements which, when the signal is narrowband compared to the inverse of the delay induced by the transmission time difference between antenna elements, is equivalent to applying an appropriate phase component to the antenna element to compensate for the motion-induced change. The angle compensation is passed to beamforming adaptation block 186.

Beamforming adaptation block 186 performs the beamforming based on the angle compensation. The beam orientation is pre-compensated based on the signal from angle compensation block 184. This is pre-applied to the phase array for compensation. The pre-compensation is applied to phase shifters 192 to shift the phases of antennas 196. A pre-compensation angle is added or removed. In single compensation, the angle is removed. The beamforming adaptation may be analog. Beamforming may involve handshaking between the transmitter and receiver. In one example, several combinations of phase angles between the transmitter and receiver are tested. For example, the receiver selects an angle, and the transmitter sweeps through several angles to find the best transmission. Then, the receiver selects another angle, and the transmitter again sweeps through several angles. This process continues until a pair of angles is found and selected. The beamforming adaptation is passed to device rotation block 188.

Device rotation block 188 modifies the phases sent to phase shifters 192 to include device rotation. This is based on the position and orientation information from INS 182 and the beamforming adaptation from beamforming adaptation block 186.

When transmitting a signal, the digital input signals are received by DACs 190, where they are converted from digital signals to analog signals. Digital beamforming may be performed.

Phase shifters 192 determine the phases for antennas 196 based on the signal from device rotation block 188 and the signals from DACs 190. Beamforming causes antennas 196 of phase array 194 to output beams 198 so particular angles experience constructive interference while other angles experience destructive interference. Phase arrays 194 are electrically phased steered arrays of millimeter wave antennas. Phase arrays 194 are arrays of antennas in which signals are fed to the antennas so the output signal is transmitted in the desired direction towards the receivers. Beamforming is used in both transmitting and receiving to achieve spatial selectivity. To change the directionality of the beam when transmitting, phase shifters control the phase and relative amplitude of the signal at each antenna to create a pattern of constructive or destructive interference in the wavefront. Analog beamforming using digitally controlled phase shifters reduces the power consumption and complexity of a large number of RF chains in an array. Duplex analog beamforming may be implemented with one ADC and one DAC. The data to be transmitted is multiplied by a transmit beamforming unit norm vector. The beamforming is pre-compensated for the device rotation and/or motion. In one example, the beam orientation is analog. Alternatively, the beam orientation is quantized.

In one example, millimeter wave transmitter 180 is on a communications controller or base station. In another example, millimeter wave transmitter 180 is on a user equipment. In additional examples, millimeter wave transmitter 180 is mounted on a vehicle or on a tower.

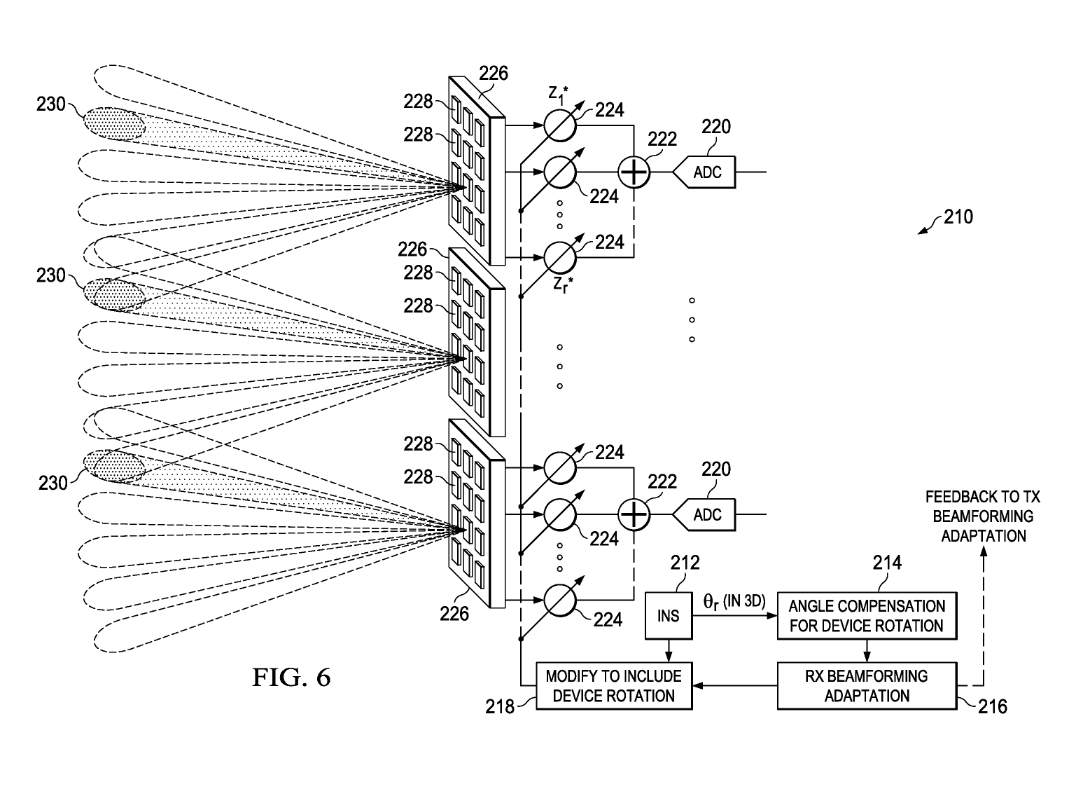

FIG. 6 illustrates millimeter wave receiver 210. Millimeter wave beams 230 are received by antennas 228 in phase arrays 226. Phase shifters 224 cause phase arrays 226 to receive a millimeter wave beam in a particular direction using constructive and destructive interference. The received signals from antennas 228 are passed to phase shifters 224, which are controlled by device rotation block 218. The outputs from phase shifters 224 are combined by combiners 222, and converted from analog signals to digital signals by ADCs 220. Digital beamforming may occur.

INS 212 determines the position, orientation, velocity and angular momentum of the device. INS 212 may contain, or have access to the output of, GPS receivers, accelerometers, gyroscopes, magnetometers, and/or digital compasses. INS 212 determines the position and orientation of phase arrays 226. INS 212 may be any device which determines orientation information. GPS provides the location of the unit. Accelerometers determine the physical acceleration experienced by phase array 226. Gyroscopes measure the orientation based on the angular momentum. Some example gyroscopes include electronic, microchip-packaged MEMS gyroscopes, solid state ring lasers, fiber-optic gyroscopes, quantum gyroscopes and other gyroscopes that will be apparent to those skilled in the art. Magnetometers measure the magnetic field at a point in space, which may be used as a digital compass. Based on the signals from the various sensors, the position and orientation are determined. This information is passed to angle compensation block 214 and device rotation block 218 in the form of θᵣ, the receiving angle, a continuous time real signal, in three dimensions, which indicates the angle of the device relative to a reference angle. In one example, a beam angle rotation estimator is used. In one example, one INS is in the device, which is used for both transmitting and receiving.

Angle compensation block 214 determines the angular compensation for the device performance. The angle compensation is passed to beamforming adaptation block 216. The array is pre-compensated for the angle, where an angle is added or removed. In single compensation, the angle is removed. The pre-compensation is applied to phase shifters 224 to shift the phase of antennas 228. Then, beamforming is performed.

Beamforming adaptation block 216 performs the beamforming based on the angle compensation. The beamforming adaptation may be analog. In one example, several different angles for a receiver and a transmitter pair are considered to determine a suitable angle combination. In one example, several angles are swept through by the receiver. The transmitter tries a different angle, and the receiver again sweeps through multiple angles. An angle where the receiver receives a significant portion of the transmitted millimeter wave signal is found and used.

The beamforming adaptation is passed to device rotation block 218. The beamforming adaptation signal is fed back to beamforming adaptation block 186. Device rotation block 218 modifies the phases to phase shifters 224 to include device rotation. This is based on the position and orientation information from INS 212 and the beamforming adaptation from beamforming adaptation block 216. In one example, the beam orientation is analog. Alternatively, the beam orientation is quantized.

Rotation compensation may occur at the transmitter, at the receiver, or at both the transmitter and receiver. When one device is stationary, rotation compensation may occur in only one end. The same device may perform rotation compensation for both transmitting and receiving.

Millimeter wave receiver 210 may be an element of a UE, a communications controller, or another device, such as a device mounted on a tower or a vehicle. A device may have both a transmitter and a receiver for millimeter waves. The pre-compensation may be performed only by the transmitter, only by the receiver, or by both the transmitter and the receiver. One pre-compensating device may be used for both the transmitter and the receiver in a transceiver. The receiver and transmitter may share an INS, an angle compensation block, and a device rotation block.

In one embodiment, compensation and re-inclusion of the phase occurs digitally.

In one embodiment, channel estimation is facilitated by a-priori carrier frequency offset (CFO). Tracking of changes in DoD/DoA associated with changes in position is facilitated by attenuation of the DoD/DoA changes associated with rotation.

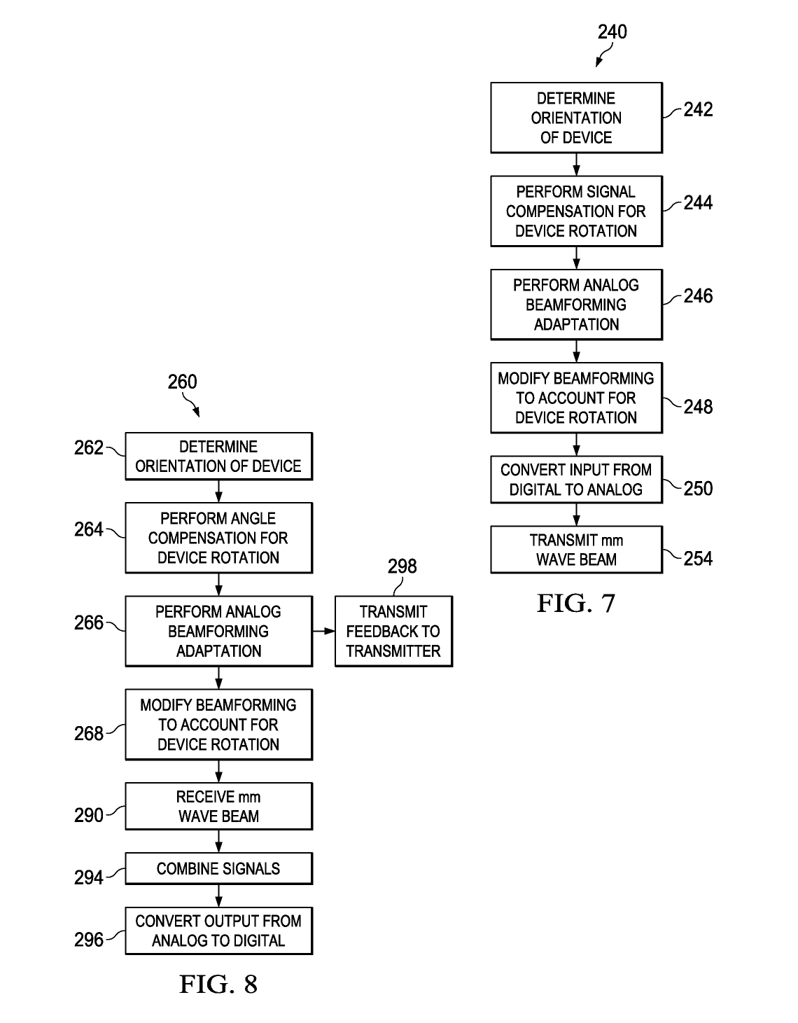

FIG. 7 illustrates flowchart 240 for a method of transmitting millimeter waves. This method may be triggered, for example, when a device is powered on. Transmitting millimeter waves may be performed by a communications controller, a user equipment, or another device, for example mounted on a vehicle. Initially, in step 242, the device determines its orientation. The orientation information may be obtained using a GPS receiver, accelerometers, gyroscopes, magnetometers, and/or digital compasses. A GPS receiver provides the location of the unit. Accelerometers determine the physical acceleration experienced by the device. Gyroscopes measure the orientation based on the angular momentum. Gyroscopes may be electronic, microchip-packaged MEMS gyroscopes, solid state ring lasers, fiber-optic gyroscopes, quantum gyroscopes or other gyroscopes that will be known to those skilled in the art. Magnetometers measure the magnetic field at a point in space, and may act as digital compasses. Based on the signals from the various sensors, the position and orientation are determined. Beam angle rotation estimation may be used to enhance the INS measurements. θₜ, a continuous signal in three dimensions, is a real time signal indicating the angle of the device relative to a reference angle. The angle indicates the 3D phase rotation.

Next, in step 244, the angle compensation for device rotation is performed. The angle of the device relative to a receiver is determined. The change in phase to account for a change in the relative orientation of the transmitter and receiver is determined. This is pre-compensated for before step 246 is performed.

Then, in step 246, analog beamforming adaptation is performed. This step may involve handshaking with the receiver. In one example, the transmitter and receiver sweep through a range of transmission and receiver phase orientations. At the various combinations, the transmitter transmits a test signal. The receiver receives the test signal, and determines the amount of energy received. The receiver and transmitter determine a suitable combination of angles.

In step 248, the beamforming is modified to account for device rotation. This helps to find good angles for the phase compensation. In an example, beamforming is done after pre-compensation.

An input signal to be transmitted is converted from digital to analog in step 250. The input signal is the signal to be transmitted by the millimeter wave transmitter to a millimeter wave receiver.

Finally, in step 254, the millimeter wave signal is transmitted from the transmitter to a receiver. Phase shifters cause a millimeter wave beam to be transmitted in the direction of a millimeter wave receiver.

Steps 250 and 254 for transmission may be repeated for many signals to be transmitted. Steps 242, 244, 246, and 248 for calibration may be repeated periodically to maintain alignment. In another example, these steps are just performed once. Alternatively, these steps are repeated when there is an indication that calibration is desirable. For example, when the orientation of a device changes, or when communication between the transmitter and receiver becomes problematic.

FIG. 8 illustrates flowchart 260 for a method of receiving millimeter waves. This method may be performed by a user equipment, a communications controller, or another device, for example a device mounted on a vehicle. Initially, in step 262, the orientation of the device is determined. The orientation information may be obtained using a GPS receiver, accelerometers, gyroscopes, magnetometers, and/or digital compasses. GPS provides the location of the unit. Accelerometers determine the proper acceleration, the weight experienced at rest in the frame of reference of the accelerometer device. Gyroscopes measure the orientation based on the angular momentum. Gyroscopes may be electronic, microchip-packaged MEMS gyroscopes, solid state ring lasers, fiber-optic gyroscopes, quantum gyroscopes, or other gyroscopes that will be apparent to those skilled in the art. Magnetometers measure the magnetic field at a point in space, which may be used as a digital compass. Based on the signals from the various sensors, the position and orientation are determined. A beam angle rotation may be used to enhance the INS signal. θᵣ, a continuous signal in three dimensions, is a real time signal indicating the angle of the device relative to a reference angle, indicating the 3D phase rotation.

Next, in step 264, angle compensation for the device rotation is performed. The orientation of the device relative to a known axis is used to approximately determine the orientation between the receiver and the receivers. This may be pre-compensated before analog beamforming adaptation by adding or removing an angle.

Then, in step 266, analog beamforming adaptation is performed. Analog beamforming and/or digital beamforming may be performed. This may involve handshaking between the transmitter and receiver. The receiver and transmitter may sweep through a range of test angles. The transmitter transmits a test signal, which the receiver receives. A suitable combination of angles may be determined and applied.

In step 298, the receiver transmits feedback to the transmitter. In one example, the receiver transmits the selected transmitter angle to the transmitter.

In step 268, the receiver modifies the beamforming to account for device rotation. This is applied to the phase shifters, so the phased array looks for an incoming millimeter wave beam in the appropriate direction.

The receiver receives millimeter wave beams in step 290. The phased array is looking in the direction of the transmitter to receiver the millimeter wave beams.

Next in step 294, the signals from the antennas of the phase arrays are combined. This determines the received signal.

Finally, in step 296, the received signal is converted from analog to digital. In the digital domain, digital beamforming may be performed.

Many signals may be received between calibrations. Calibrations may occur when the device turns on, periodically, or when there is an indication that calibration should be performed, for example, when an orientation of a device changes, or when the received signal is below a threshold (e.g. low in power).

In one embodiment, a device provides feedback of its channel measurements. For example, the feedback is provided with respect to an absolute reference. The absolute reference may not be perfectly known, but it is a reference which is not internal to the user. For instance, a device may measure signal strength with respect to one or more of N beam patterns. These measurements may be fed back to an external entity along with the some beam pattern identifier. Internally these beam patters are related to the combining of the signals from different antennas. To maximize the usefulness of fed back information this beam pattern identifier may be made with respect to an absolute reference. Thus, the feedback beam identifier may be translated into another beam identifier based on the device's current orientation.

In one example, this occurs when an external node schedules a transmission, with the scheduling of data either out of band or using a different pre-coder. For example, there may be N distinct beam patterns, or a subset or superset of those N patterns. However, the mapping to those N patterns is a function of the UE's measured position. When the format is an angle of arrival (AoA) or angle of departure (AoD) based format, the AoA or AoD used for feedback/measurement is the translated an AoA or AoD based on the UE's orientation.

In another embodiment, a device receives control information with respect to an absolute reference. For example, a scheduling control channel indicates to a user to transmit on beam Y. Beam Y refers to a spatial direction with respect to an absolute reference. This facilitates a remote device intelligently scheduling resources without considering rotation of the transmitting device.

In one example, a UE transmits beams in one of 30 directions. The UE is under the control of a communications controller, which indicates the time, frequency, and direction of transmission of beams to the UE for the UE's transmission. In one example, there is an explicit pre-coder indication which indicates which pre-coding scheme that UE should use. The pre-coding angle may go through angle compensation. Thus, the absolute angle of transmission is respected while the relative angle form the UE's antennas is not respected. Other characteristics, such as power level and modulation and coding scheme (MCS), may be adjusted to reflect changes in the UE's ability to transmit in this new direction. For example, when the transmit signal strength is low or high, the transmit power may be adjusted up or down to compensate. Alternatively, the MCS may be adjusted to account for the decrease or increase in received signal strength.

Angle compensation techniques may be applied to many signals, including pilot signals, as well as to data. Thus when the UE rotates during pilot transmission, the rotation may be compensated for in the pilot transmission.

Angle compensation may also be applied in the feedback. When performing channel measurements, the signal strength may be measured with respect to an absolute measurement, rather than the current UE antenna measurements. Channel feedback may be performed in many ways, for example by measuring and feeding back a measure of the channel H, multiplied by an agreed upon pre-coding matrix P. This pre-coding matrix may be implemented in the analog domain, the digital domain, or a mixture of the two. However, when the device is rotated during channel measurement, the channel H may no longer represent a measure of the channel at any time. Channel compensation may then be applied by changing the received beamforming, so the rotation may be partially undone. For example, the channel used for channel feedback is from new receivers based on adjusted angles, or by digitally adjusting the appropriate channel measurements.

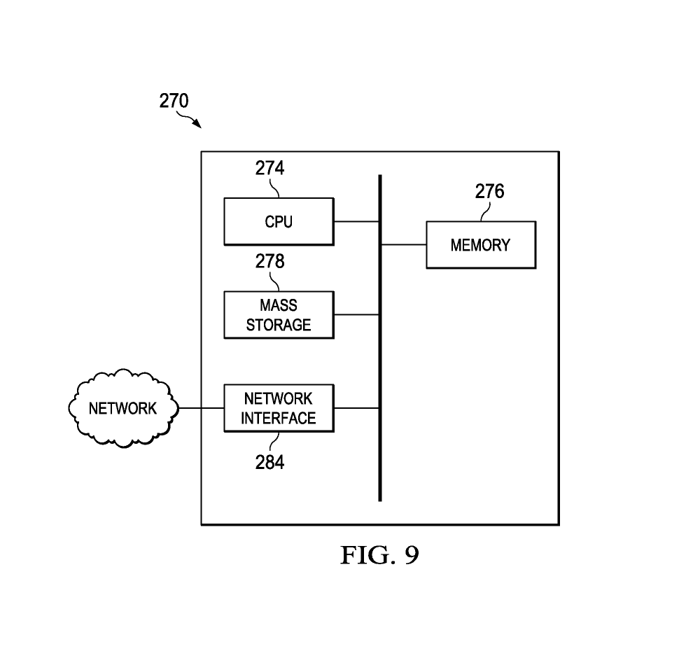

FIG. 9 illustrates a block diagram of processing system 270 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input devices, such as a microphone, mouse, touchscreen, keypad, keyboard, and the like. Also, processing system 270 may be equipped with one or more output devices, such as a speaker, a printer, a display, and the like. The processing unit may include central processing unit (CPU) 274, memory 276, mass storage device 278, video adapter 280, and I/O interface 288 connected to a bus.

The bus may be one or more of any type of several bus architectures including a memory bus or memory controller, a peripheral bus, video bus, or the like. CPU 274 may comprise any type of electronic data processor. Memory 276 may comprise any type of non-transitory system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

Mass storage device 278 may comprise any type of non-transitory storage device configured to store data, programs, and other information and to make the data, programs, and other information accessible via the bus. Mass storage device 278 may comprise, for example, one or more of a solid state drive, hard disk drive, a magnetic disk drive, an optical disk drive, or the like.

The processing unit also includes one or more network interface 284, which may comprise wired links, such as an Ethernet cable or the like, and/or wireless links to access nodes or different networks. Network interface 284 allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for beam alignment, the method comprising:
determining an orientation of a device;
performing angle compensation in accordance with the orientation of the device;
performing beamforming adaptation; and
modifying the beamforming adaptation in accordance with the orientation of the device.

2. The method of claim 1, wherein modifying the beamforming adaptation comprises modifying a plurality of phase shifters of a phase array.

3. The method of claim 2, further comprising transmitting a millimeter wave beam by the phase array after modifying the plurality of phase shifters.

4. The method of claim 3, further comprising:
receiving an input digital signal;
converting the input digital signal to an input analog signal; and
adjusting the plurality of phase shifters in accordance with the input analog signal.

5. The method of claim 2, further comprising receiving a millimeter wave beam by the phase array after modifying the plurality of phase shifters.

6. The method of claim 5, further comprising:
combining a plurality of signals from a plurality of antennas of the phase array to produce a combined analog signal; and
converting the combined analog signal to an output digital signal.

7. The method of claim 2, wherein the device is a transmitter, and wherein performing beamforming adaptation comprises:
applying a first test angle to the phase array;
transmitting a first test signal to a receiver at the first test angle;
applying a second test angle to the phase array;
transmitting a second test signal to the receiver at the second test angle; and
receiving an input signal from the receiver, wherein the signal indicates a quality of the first test angle and a quality of the second test angle.

8. The method of claim 2, wherein the device is a receiver, and wherein performing beamforming adaptation comprises:
applying a first test angle to the phase array;
receiving a first test signal from a transmitter at the first test angle;
applying a second test angle to the phase array;
receiving a second test signal from the transmitter at the second test angle; and
transmitting an output signal to the transmitter, wherein the signal indicates the first test angle or the second test angle.

9. The method of claim 1, further comprising performing digital beamforming adaptation.

10. The method of claim 1, further comprising:
measuring a signal strength with respect to a reference; and
performing channel feedback in accordance with the signal strength.

11. The method of claim 1, further comprising receiving, by the device, a control message comprising a direction with respect to a reference, wherein performing angle compensation further comprises performing angle compensation in accordance with the direction.

12. The method of claim 1, further comprising:
receiving, by the device, a message comprising a pre-coder indication; and
performing pre-coding compensation in accordance with the pre-coder indication.

13. A device comprising a beam transmitter, wherein the beam transmitter comprises:
a phase array comprising
a plurality of antennas, wherein the plurality of antennas is configured to transmit a beam to a receiver, and
a plurality of phase shifters coupled to the phase array;
an inertial navigation system configured to determine an orientation of the device; and
a beamforming module configured to perform analog beamforming on the plurality of phase shifters in accordance with the orientation of the device.

14. The device of claim 13, further comprising a beam receiver coupled to the beam transmitter.

15. The device of claim 13, wherein the inertial navigation system receives an input from a global positions system (GPS) receiver.

16. The device of claim 13, wherein the inertial navigation system receives an input from an accelerometer.

17. The device of claim 13, wherein the inertial navigation system receives an input from a gyroscope.

18. The device of claim 13, wherein the inertial navigation system receives an input from a magnetometer.

19. The device of claim 13, wherein the inertial navigation system comprises a beam angle rotation estimator.

20. The device of claim 13, wherein the device is a communications controller.

21. The device of claim 13, wherein the device is a user equipment.

22. A device comprising a beam receiver, wherein the beam receiver comprises:
a phase array comprising
a plurality of antennas, wherein the plurality of antennas is configured to receive a millimeter wave beam to a receiver, and
a plurality of phase shifters coupled to the phase array;
an inertial navigation system configured to determine an orientation of the beam receiver; and
a beamforming module configured to perform analog beamforming on the plurality of phase shifters in accordance with the orientation of the beam receiver.

23. The device of claim 22, wherein the inertial navigation system comprises one or more of a global positions system (GPS) receiver, an accelerometer, a gyroscope, and a digital compass.

24. The device of claim 22, wherein the inertial navigation system comprises a beam angle rotation estimator.

25. The device of claim 22, wherein the device comprises a user equipment (UE).

26. The device of claim 22, wherein the device comprises a communications controller.

27. A controller comprising:
a processor; and
a non-transitory computer readable storage medium storing programming for execution by the processor, the programming including instructions to
determine an orientation of a device,
perform angle compensation in accordance with the orientation of the device,
perform beamforming adaptation, and
modify the beamforming adaptation in accordance with the orientation of the device.

28. The controller of claim 27, wherein the device comprises the controller.

29. The controller of claim 27, wherein the device is a user equipment (UE).

30. The controller of claim 27, wherein the device is a communications controller.
